(19) United States
(12) Patent Application Publication
(10) Pub. No.: US 2024/0103591 A1
(43) Pub. Date: Mar. 28, 2024

(54) Power Management Using Temperature Gradient Information

(71) Applicants: Advanced Micro Devices, Inc, Santa Clara, CA (US); ATI Technologies ULC, Markham (CA)

(72) Inventors: Adam Neil Calder Clark, Victoria (CA); Anil Harwani, Austin, TX (US); Amitabh Mehra, Fort Collins, CO (US)

(73) Assignee: ATI Technologies ULC, Markham, ON (CA)

(21) Appl. No.: 18/148,098

(22) Filed: Dec. 29, 2022

Related U.S. Application Data
(60) Provisional application No. 63/410,175, filed on Sep. 26, 2022.

(51) Int. Cl. G06F 1/20

(52) U.S. Cl. CPC G06F 1/206

(57) ABSTRACT

Power management using temperature gradient information is described. In accordance with the described techniques, temperature measurements of a component are obtained from two or more sensors of the component. A temperature of a hotspot of the component is predicted based on the temperature measurements obtained from the two or more sensors of the component. Operation of the component is adjusted based on the predicted temperature of the hotspot.

### RELATED APPLICATION

This application claims priority under 35 U.S.C. § 119(e) to U.S. Provisional Patent Application No. 63/410,175, filed Sep. 26, 2022, and titled “Power Management Using Temperature Gradient Information,” the entire disclosure of which is hereby incorporated by reference.

### BACKGROUND

Typically, computing systems have a discreet number of sensors (e.g., thermal sensors) to sense one or more conditions of portions of a computing system, e.g., of one or more components of the computing system. In scenarios where the sensors are thermal sensors that sense temperature of respective portions of the computing system, the system may use the sensed temperatures to control operation of the computing system.

### BRIEF DESCRIPTION OF THE DRAWINGS

FIG. 1 is a block diagram of a non-limiting example system having a memory and a controller operable to implement power management using temperature gradient information.

FIG. 2 is a block diagram of a non-limiting example in which a thermal hotspot of a component corresponds to a different location of the component from locations of sensors.

FIG. 3 depicts a procedure in an example implementation of power management using temperature gradient information.

FIG. 4 depicts a non-limiting example of a printed circuit board architecture for a high bandwidth memory system.

### DETAILED DESCRIPTION

Overview

Typically, computing systems have a discreet number of sensors (e.g., thermal sensors) to sense one or more conditions of portions of a computing system, e.g., of one or more components of the computing system. In scenarios where the sensors are thermal sensors that sense temperature of respective portions of the computing system, however, there may be a thermal hotspot that is not reflected in the temperatures produced by the sensors. By way of example, this occurs in scenarios where the thermal hotspot is located at a different portion of the computing system from where the thermal sensors are disposed. Thus, in conventional approaches, system managers determine operating parameters (e.g., voltage and frequency) using a highest temperature measured by the sensors, which often does not correspond to the actual hottest portion of the computing system.

Due to localized hotspotting effects, where components' actual hotspots are at locations different from where sensors are disposed in the system thus causing the actual temperatures of those hotspots not to be recorded, conventional approaches rely on inherently erroneous hottest temperatures. In some cases, conventional approaches add a guardband, e.g., to voltage curves, to account for this error. By adding a guardband that is too large, though, conventional techniques fail to optimize performance and/or efficiency of the systems. Additionally, by adding a guardband that is insufficient to account for the actual temperature of the thermal hotspot, e.g., too small for the addition of the guardband to cover the actual highest temperature, conventional approaches can cause loss of stability for one or more components of the system and/or degradation of components.

To solve these problems, power management using temperature gradient information is described. In contrast to conventional approaches, a system manager receives data produced by a plurality of sensors over time (e.g., temperatures) and logs this data. The system manager predicts a location and/or temperature of one or more thermal hotspots of a component and/or the system based on the data produced by the sensors. The system manager then adjusts operation of the component (e.g., a processor, processor cores, a memory, and/or portions of the memory) based on the predicted temperature. Notably, the temperature and location of a hotspot predicted according to the described techniques is more accurate than conventional techniques which throttle operation based on a temperature of a hottest sensor. More accurate determination of system and/or component temperatures is particularly advantageous for overclocking, as temperature impacts whether higher performance of the system is achievable.

Moreover, at least one example advantage of the described techniques is that they can reduce a number of sensors which are incorporated in computing systems. In order for conventional approaches, which assume that a hottest measured temperature corresponds to the hottest temperature of the system, to be more accurate, such techniques would need to increase a density of sensors throughout the system. However, sensors consume area or volume of the system and adding more of them takes up more area or volume, resulting in physically larger systems (e.g., systems on chip), which can be more expensive than designs with fewer sensors. By way of contrast, the described techniques achieve greater accuracy with fewer sensors than conventional approaches. Additionally, some components like arithmetic logic units, are not configurable to include sensors. Due to this, conventional approaches that rely on a highest measured temperature from a sensor are not suitable for determining a hottest portion of a system that includes such components.

In some aspects, the techniques described herein relate to a system including: a processor, a first thermal sensor positioned at a first portion of the processor, a second thermal sensor positioned at a second portion of the processor, and a system manager configured to: obtain a first temperature measurement from the first thermal sensor and a second temperature measurement from the second thermal sensor, predict a temperature of a hotspot on the processor based on the first temperature measurement and the second temperature measurement, and adjust one or more settings of the processor based on the predicted temperature of the hotspot.

In some aspects, the techniques described herein relate to a system, wherein the predicted temperature at the hotspot is higher than the first temperature measurement and the second temperature measurement.

In some aspects, the techniques described herein relate to a system, wherein the hotspot is located at a different portion of the processor from where the first thermal sensor and the second thermal sensor are disposed.

In some aspects, the techniques described herein relate to a system, wherein the system manager is configured to predict the temperature of the hotspot by: determining a temperature delta between the first temperature measurement and the second temperature measurement, determining a slope of the temperature delta, and predicting the temperature of the hotspot based on the slope of the temperature delta.

In some aspects, the techniques described herein relate to a system, wherein the first thermal sensor and the second thermal sensor are positioned at first and second portions of a core of the processor.

In some aspects, the techniques described herein relate to a system, wherein the system manager is further configured to adjust the one or more settings of the core to keep temperature measurements from the first thermal sensor within a threshold of temperature measurements from the second thermal sensor.

In some aspects, the techniques described herein relate to a system, wherein the first thermal sensor is positioned at a first core of the processor and the second thermal sensor is positioned at a second core of the processor.

In some aspects, the techniques described herein relate to a system, wherein the system manager is further configured to adjust the one or more settings of at least one of the first core or the second core to keep temperature measurements from the first thermal sensor within a threshold of temperature measurements from the second thermal sensor.

In some aspects, the techniques described herein relate to a system, wherein the system is a system-on-chip.

In some aspects, the techniques described herein relate to a method including: obtaining temperature measurements of a component from two or more sensors of the component, predicting a temperature of a hotspot of the component based on the temperature measurements obtained from the two or more sensors of the component, and adjusting operation of the component based on the predicted temperature of the hotspot.

In some aspects, the techniques described herein relate to a method, wherein the hotspot is located at a different portion of the component from where the two or more sensors are disposed.

In some aspects, the techniques described herein relate to a method, wherein the predicted temperature of the hotspot is higher than the obtained temperature measurements.

In some aspects, the techniques described herein relate to a method, wherein the component includes a processor.

In some aspects, the techniques described herein relate to a method, wherein the component includes a memory.

In some aspects, the techniques described herein relate to a method, wherein the predicting further includes: determining a temperature delta between the temperature measurements obtained from the two or more sensors of the component, determining a slope of the temperature delta between the two or more sensors of the component, and predicting the temperature of a hotspot of the component based on the slope of the temperature delta between the two or more sensors of the component.

In some aspects, the techniques described herein relate to a method, wherein the adjusting keeps the temperature measurements from the two or more sensors within a threshold temperature difference.

In some aspects, the techniques described herein relate to a device including: a stacked memory having a plurality of memory dies, and a system manager configured to: obtain temperature measurements from thermal sensors associated with different memory dies of the stacked memory, predict a hotspot of the stacked memory based on a difference between the temperature measurements from the thermal sensors, and adjust one or more settings of the stacked memory based on the predicted hotspot.

In some aspects, the techniques described herein relate to a device, wherein prediction of the hotspot predicts a temperature of the hotspot and a location within the stacked memory of the hotspot.

In some aspects, the techniques described herein relate to a device, wherein the predicted location of the hotspot corresponds to at least one memory die of the plurality of memory dies.

In some aspects, the techniques described herein relate to a device, wherein the thermal sensors are disposed at least one of on the plurality of memory dies or between the plurality of memory dies.

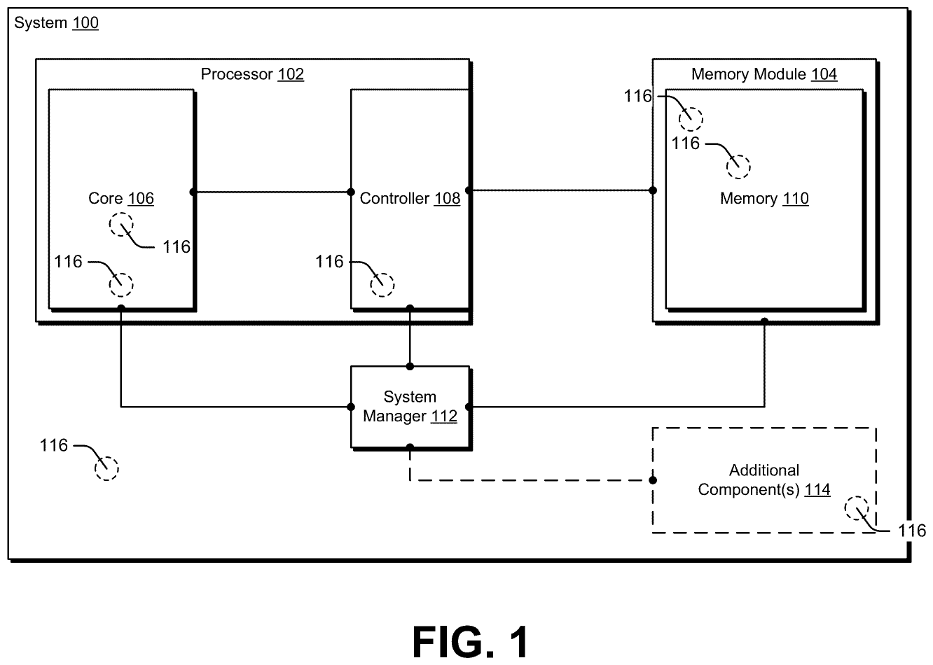

FIG. 1 is a block diagram of a non-limiting example system 100 having a memory and a controller operable to implement power management using temperature gradient information. In this example, the system 100 includes processor 102 and memory module 104. Further, the processor 102 includes a core 106 and a controller 108. The memory module 104 includes memory 110. In one or more implementations, the system 100 also includes a system manager 112, and the memory module 104 includes a processing-in-memory component (not shown). In the illustrated example, the system 100 is also depicted with additional component(s) 114 (e.g., cache, secondary storage, semiconductor intellectual property core, etc.), which represents that, in variations, the system 100 includes one or more optional, additional components 114. It is to be appreciated that in at least one variation, the system 100 does not include one or more of the depicted components and/or includes different components without departing from the spirit or scope of the described techniques.

In accordance with the described techniques, the processor 102 and the memory module 104 are coupled to one another via a wired or wireless connection. The core 106 and the controller 108 are also coupled to one another via one or more wired or wireless connections. The other components of the system 100 are connectable via wired and/or wireless connections. Example wired connections include, but are not limited to, buses (e.g., a data bus), interconnects, through silicon vias, traces, and planes. Examples of devices in which the system 100 is implemented include, but are not limited to, servers, personal computers, laptops, desktops, game consoles, set top boxes, tablets, smartphones, mobile devices, virtual and/or augmented reality devices, wearables, medical devices, system-on-chip, and other computing devices or systems.

The processor 102 is an electronic circuit that performs various operations on and/or using data in the memory 110. Examples of the processor 102 include, but are not limited to, a central processing unit (CPU), a graphics processing unit (GPU), a field programmable gate array (FPGA), an accelerated processing unit (APU), and a digital signal processor (DSP). The core 106 is a processing unit that reads and executes instructions (e.g., of a program), examples of which include to add, to move data, and to branch. Although one core 106 is depicted in the illustrated example, in variations, the processor 102 includes more than one core 106, e.g., the processor 102 is a multi-core processor.

In one or more implementations, the memory module 104 is a circuit board (e.g., a printed circuit board), on which the memory 110 is mounted. In variations, one or more integrated circuits of the memory 110 are mounted on the circuit board of the memory module 104. Examples of the memory module 104 include, but are not limited to, a TransFlash memory module, single in-line memory module (SIMM), and dual in-line memory module (DIMM). In one or more implementations, the memory module 104 is a single integrated circuit device that incorporates the memory 110 on a single chip or die. In one or more implementations, the memory module 104 is composed of multiple chips or dies that implement the memory 110 that are vertically (“3D”) stacked together, are placed side-by-side on an interposer or substrate, or are assembled via a combination of vertical stacking or side-by-side placement.

The memory 110 is a device or system that is used to store information, such as for immediate use in a device, e.g., by the core 106 of the processor 102 and/or by a processing-in-memory component. In one or more implementations, the memory 110 corresponds to semiconductor memory where data is stored within memory cells on one or more integrated circuits. In at least one example, the memory 110 corresponds to or includes volatile memory, examples of which include random-access memory (RAM), dynamic random-access memory (DRAM), synchronous dynamic random-access memory (SDRAM), and static random-access memory (SRAM). Alternatively or in addition, the memory 110 corresponds to or includes non-volatile memory, examples of which include Ferro-electric RAM, Magneto-resistive RANI, flash memory, read-only memory (ROM), programmable read-only memory (PROM), erasable programmable read-only memory (EPROM), electronically erasable programmable read-only memory (EEPROM), and non-volatile dual in-line memory module (DIMM) (NVDIM M).

In one or more implementations, the memory 110 is configured as a dual in-line memory module (DIMM). A DIMM includes a series of dynamic random-access memory integrated circuits, and the modules are mounted on a printed circuit board. Examples of types of DIMMs include, but are not limited to, synchronous dynamic random-access memory (SDRAM), double data rate (DDR) SDRAM, double data rate 2 (DDR2) SDRAM, double data rate 3 (DDR3) SDRAM, double data rate 4 (DDR4) SDRAM, and double data rate 5 (DDR5) SDRAM. In at least one variation, the memory 110 is configured as a small outline DIMM (SO-DIMM) according to one of the above-mentioned SDRAM standards, e.g., DDR, DDR2, DDR3, DDR4, and DDR5. In one or more implementations, the memory 110 is low-power double data rate (LPDDR), also known as LPDDR SDRAM, and is a type of synchronous dynamic random-access memory. In variations, LPDDR consumes less power than other types of memory and/or has a form factor suitable for mobile computers and devices, such as mobile phones. Examples of LPDDR include, but are not limited to, low-power double data rate 2 (LPDDR2), low-power double data rate 3 (LPDDR3), low-power double data rate 4 (LPDDR4), and low-power double data rate 5 (LPDDR5). It is to be appreciated that the memory 110 is configurable in a variety of ways without departing from the spirit or scope of the described techniques.

The controller 108 is a digital circuit that manages the flow of data to and from the memory 110. By way of example, the controller 108 includes logic to read and write to the memory 110 and interface with the core 106, and in variations to interface with a processing-in-memory component. For instance, the controller 108 receives instructions from the core 106 which involve accessing the memory 110, and the controller 108 provides data from the memory 110 to the core 106, e.g., for processing by the core 106. In one or more implementations, the controller 108 is communicatively and/or topologically located between the core 106 and the memory module 104, and the controller 108 interfaces with both the core 106 and the memory module 104.

In one or more implementations, the system manager 112 includes or is otherwise configured to interface with one or more systems capable of updating operation of various components of the system 100, examples of such systems include but are not limited to an adaptive voltage scaling (AVS) system, an adaptive voltage frequency scaling (AVFS), and a dynamic voltage frequency system (DVFS). For example, the system manager 112 uses such systems to adjust settings (e.g., voltage, frequency, timings, etc.) with which the various components of the system operate. In one or more implementations, the system manager 112 is configured as a microcontroller disposed on a die running firmware to perform a variety of the operations discussed above and below.

In accordance with the described techniques, for instance, the system manager 112 is configured to adjust operation of one or more components of the system dynamically, such as by communicating a change signal to adjust a frequency, voltage, and/or timings at which components of the system operate. Although the system manager 112 is depicted separately from the processor 102 and the memory module 104, in one or more implementations, the system manager 112 is included as part of the processor 102, the memory module 104, or the additional component(s) 114. Alternatively or additionally, one or more components of the system 100 include a component manager (not shown), which performs one or more of the operations described above and below as being performed by the system manager 112. By way of example, and not limitation, the processor 102 and the memory module 104 each include a component manager, operable to implement power management using temperature gradient information. Although a firmware implementation is discussed above, in one or more variations, the system manager 112 is implemented using hardware in addition to or rather than firmware. In one example, for instance, the system manager 112 is implemented using hardware in a core.

In accordance with the described techniques, the system 100 also includes a plurality of sensors 116, e.g., a plurality of thermal sensors. Although the sensors are depicted as being integral with various components of the system 100, in one or more implementations, only a single component includes the plurality of sensors 116, e.g., the core 106 or the memory module 104 or the memory 110. Alternatively or additionally, any two or more components of the system 100 includes one or more sensors of the plurality of sensors 116. Certainly, the plurality of sensors 116 can be integrated throughout the system (or throughout an individual component) in a variety of ways without departing from the spirit or scope of the described techniques.

In conventional approaches, operation of components is managed based on a temperature associated with a “hottest” sensor, and the temperature obtained from this sensor is used as a basis for throttling voltage, frequency, and so on, of various components of the system. In operation, however, a portion of a computing system having a hottest temperature may not be at a location where a sensor, e.g., a thermal sensor, is positioned. Instead, the portion of the computing system having a hottest temperature may be at a location of the computing system some distance away from where one or more of the sensors are positioned. Due to this, conventional approaches often throttle operation of one or more computing system components based on the wrong hottest temperature, e.g., a temperature that is less than the actual hottest temperature of the computing system or less than the actual hottest temperature of a component of the computing system. This can lead to instability of components during operation and/or degradation of system components over time.

In contrast to conventional approaches, in one or more implementations, the system manager 112 receives data produced by the plurality of sensors 116 over time (e.g., temperatures) and logs this data. The system manager 112 estimates a location and/or temperature of one or more thermal hotspots of a component and/or the system 100 based on the data produced by the sensors 116 over time and spatially. In at least one variation, the system manager 112 determines temperature deltas between two or more of the sensors 116 using one or more algorithms that account for temperature deltas. For example, the system manager 112 determines a slope of a temperature delta (e.g., a difference) between at least two of the sensors 116. By way of example, two or more of the sensors 116 measure differences (e.g., temperature) within a particular core, between different cores on a same piece of silicon, between different pieces of silicon within a package, e.g., a component with a stacked configuration such as Vcache and/or stacked DRAM. In at least one variation, the system 100 includes sensors 116 disposed between components, such as between different dies of a component a stacked configuration.

In one or more implementations, at least one of the algorithms is based on information obtained in pre-silicon analysis and/or information obtained in post-silicon thermal imaging/mapping. Alternatively or in addition, at least one of the algorithms is based on building one or more models from such information to calculate (e.g., estimate) local temperature hotspots given as input thermal sensor information from one or more of the sensors 116 disposed throughout the system 100. In at least one variation, the input thermal sensor information is static and corresponds to a point in time. In at least one additional variation, the input thermal sensor information corresponds to measurements from the sensors over time, e.g., an interval of time In one or more implementations, the information obtained during the analysis and/or during the thermal imaging/mapping is indicative of locations in the system 100 of various components, such as locations of various logic units in the system 100 that produce more heat than other portions of the system. As such, the algorithms account for the location of such components, which enables the location of a thermal hotspot to be predicted using the knowledge embedded in the algorithms of component locations. In one or more implementations, the system manager 112 also monitors activity (e.g., processing and/or localized power density) associated with one or more logical units, and uses this information when predicting a location and/or temperature of a thermal hotspot.

Based on the slope of one or more temperature differences, the system manager 112 predicts a temperature of the actual hotspot and/or determines a correction, e.g., from a table and/or algorithmically. The system manager 112 adds the correction to at least one of the temperature measurements produced by one or more of the sensors 116 to produce a computationally corrected temperature. In scenarios where an algorithm predicts the hottest temperature, the output of the algorithm can be used as the computationally corrected temperature. This computationally corrected temperature is then used as a basis for the system manager 112 to adjust operation of components, e.g., the system manager 112 uses the computationally corrected temperature to throttle one or more of voltage, frequency, timings, and so on, for one or more components of the system 100—rather than simply using the temperature produced by a sensor 116 (and a guardband). In one or more implementations, this includes determining an optimal voltage for one or more of the components of the system 100 based on the computationally corrected temperature. The temperature and location of a hotspot determined according to the described techniques are more accurate than conventional techniques which throttle operation based on a temperature of a hottest sensor. More accurate determination of system and/or component temperatures is particularly advantageous for overclocking, as temperature impacts whether higher performance of the system 100 is achievable.

In one or more implementations, the system manager 112 uses the temperature deltas (e.g., between sensors 116) to adjust a voltage and/or frequency operation point (or another aspect of operating components) to keep the temperature delta (e.g., between the sensors 116) within a threshold difference. By maintaining the delta between sensors 116 within a range, the system manager 112 increases the accuracy of predicting the temperature of actual hotspot locations and temperatures, e.g., using extrapolation. This is because when deltas between the sensors 116 are too large, extrapolation error is introduced into the predictions, which can cause inaccurate predictions. Thus, in one or more implementations, the system manager 112 monitors the deltas and, when the deltas satisfy a threshold difference (e.g., are larger than or equal to the difference), the system manager 112 performs one or more actions (e.g., adjusts voltage, frequency, timings, etc.) for causing the deltas to return to within the threshold. In other words, through iterations of monitoring deltas and performing actions to adjust operational aspects of the components, the system manager 112 is configured to control the deltas (e.g., the temperature deltas) between the sensors 116.

Additionally or alternatively, the system manager 112 logs the data produced by the sensors over time to generate a model of temperature changes throughout the system 100 (or components) over time, which allows for filtering and additional adjustments. By logging this data over time and generating such a model, for instance, the system manager 112 determines how different workloads affect temperatures of portions of the system 100 over time, such that the system manager 112 can subsequently “prepare” one or more components of the system 100 (e.g., throttle voltage, frequency, timings, etc.) preemptively to handle a given workload.

At least one example advantage of the described techniques is that they can reduce a number of sensors which are incorporated in computing systems. In order for conventional approaches, which assume that a hottest measured temperature corresponds to the hottest temperature of the system, to be more accurate such techniques would need to increase a density of sensors throughout the system. However, sensors consume area or volume of the system and adding more of them takes up more area or volume, resulting in physically larger systems (e.g., systems on chip), which can be more expensive than designs with fewer sensors. By way of contrast, the described techniques achieve greater accuracy with fewer sensors than conventional approaches. Additionally, some components like arithmetic logic units, are not configurable to include sensors. Due to this, conventional approaches that rely on a highest measured temperature from a sensor are not suitable for determining a hottest portion of a system that includes such components, which may correspond to those components that cannot be configured to include sensors.

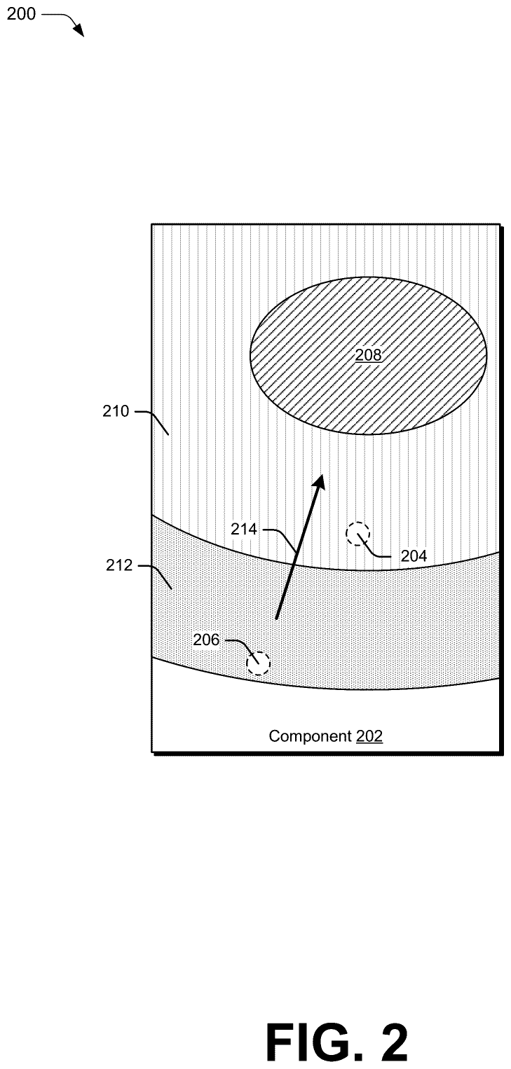

FIG. 2 is a block diagram of a non-limiting example 200 in which a thermal hotspot of a component corresponds to a different location of the component from locations of sensors.

The illustrated example 200 includes component 202, which corresponds to one or more components of the system 100. In this example 200 the component 202 includes at least a first sensor 204 and a second sensor 206, which are examples of the sensors 116. The example 200 also depicts a thermal hotspot 208 of the component 202, e.g., the actual hottest portion of the component 202. In this example 200, though, neither the first sensor 204 nor the second sensor 206 is located at the thermal hotspot 208, which corresponds to a first temperature. Instead, the first sensor 204 is located at a portion 210 of the component 202 that corresponds to a second temperature, and the second sensor 206 is located at a portion 212 of the component 202 that corresponds to a third temperature. In one or more scenarios, the second temperature at the first portion 210 is less than the first temperature at the thermal hotspot 208, and the third temperature at the second portion 212 is less than the second temperature. This example 200 depicts a scenario where the actual temperature of the component 202 increases in the direction of arrow 214.

In accordance with the described techniques, the system manager 112 obtains data (e.g., temperature measurements) from the first sensor 204 and the second sensor 206 and logs this data. The system manager 112 also determines a difference between the data produced by the first sensor 204 and the data produced by the second sensor 206, e.g., a temperature difference. For instance, the system manager 112 determines a difference between the data produced by the first sensor 204 and the second sensor 206 at substantially a same time, e.g., the system manager 112 computes the difference for correspondences in the data.

In one or more implementations, the system manager 112 computes a difference in corresponding temperatures measured (e.g., at a substantially same time) by the first sensor 204 and the second sensor 206. In other words, the system manager 112 computes a “temperature delta” between the temperature measured by the first sensor 204 and the temperature measured by the second sensor 206. With reference to the illustrated example 200, for instance, the system manager 112 determines a difference between the temperature measured by the first sensor 204, e.g., of the portion 210, and the temperature measured by the second sensor 206, e.g., of the portion 212.

In one or more implementations, the system manager 112 also determines a slope of the difference (e.g., a temperature gradient), and based on the slope, adds a correction to the raw sensor data, e.g., to the temperature measured by the first sensor 204 of the portion 210. In variations, the system manager 112 uses one or more of a variety of algorithms to compute temperature gradients over time between the various sensors 116. In at least one variation, the system manager 112 extrapolates the gradient to an opposite side of a sensor measuring the higher temperature, where the “opposite side” is opposite the sensor measuring the lower temperature. In the context of the illustrated example 200, for instance, the system manager 112 extrapolates a gradient (e.g., by continuing in a direction of the gradient) to an opposite side of the first sensor 204 from the second sensor 206. Based on this, the system manager 112 estimates or otherwise predicts the actual hottest temperature. In at least one variation, the system manager 112 also estimates or otherwise predicts a location of the hottest temperature. In one or more scenarios, the system manager 112 simply uses this predicted temperature as the hottest temperature. Alternatively or in addition, the system manager 112 corrects the raw sensor data by adding a correction to the hottest measured temperature to obtain the predicted temperature. This predicted or corrected temperature is referred to herein as the computationally corrected temperature.

Based on the computationally corrected temperature, the system manager 112 manages or adjusts settings of the system 100, such as by managing or adjusting power, frequency, timings, etc. of the component 202 and/or other components of the system 100. In one or more implementations, the system manager 112 also determines a location of the thermal hotspot 208 based on the temperature gradients between various combinations of two or more of the sensors 116, e.g., by extrapolating the gradients. In one or more implementations, the system manager 112 determines a location of one or more thermal hotspots on a same piece of silicon, e.g., a same hardware die. Alternatively or in addition, the system manager 112 determines a location of one or more thermal hotspots for a three-dimensional or 3D structure or component, such as between different die in a stacked part, e.g., Vcache or a stacked memory like DRAM. Thus, in one or more variations, the system manager manages power, frequency, timings, etc. of the component 202 and/or other components of the system 100 based on locations and temperatures of predicted (or estimated) thermal hotspots.

Although thermal sensors are discussed above and below, it is to be appreciated that in variations, the system 100 includes additional or different types of sensors. In such variations, the system manager 112 is configured to determine differences between the data produced by such other types of sensors (e.g., using one or more algorithms), add a correction to the sensor data produced by at least one of the sensors, and manage one or more of the components based on the computationally corrected data rather than using the raw sensor data.

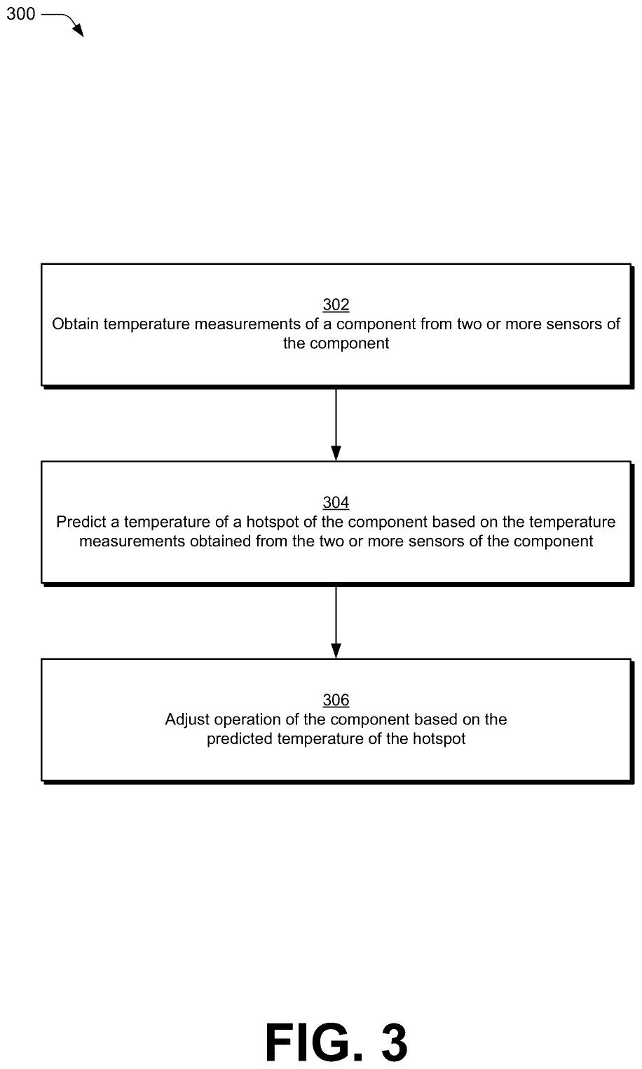

FIG. 3 depicts a procedure in an example 300 implementation of power management using temperature gradient information.

Temperature measurements of a component are obtained from two or more sensors of the component (block 302). A temperature of a hotspot of the component is predicted based on the temperature measurements obtained from the two or more sensors of the component (block 304). Operation of the component is adjusted based on the predicted temperature of the hotspot (block 306).

In one or more implementations, the memory module 104 corresponds to or otherwise includes a stacked memory, e.g., DRAM. The system 100 is capable of taking advantage of sensors 116 disposed throughout 3D memories (e.g., DRAM) and improves interprocess communication (IPC) by determining a computationally corrected temperature refresh using temperature deltas (e.g., gradients) and thus increasing performance (e.g., overclocking) dynamically of portions of a stacked memory capable of handling the increase.

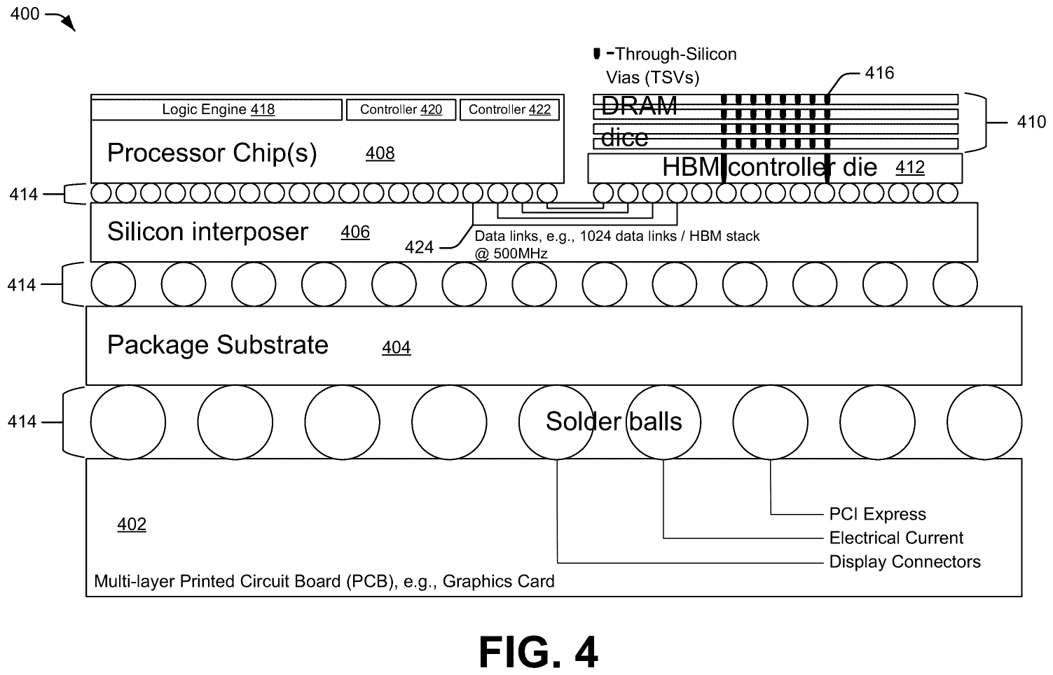

High bandwidth memory (HBM) provides increased bandwidth and memory density, allowing multiple layers (e.g., tiers) of DRAM dies (e.g., 8-12 dies) to be stacked on top of one another with one or more optional logic/memory interface die. Such a memory stack can be connected to a processing unit (e.g., CPU and/or GPU) through silicon interposers, as discussed in more detail below in relation to FIG. 4. Alternatively or additionally, such a memory stack can be stacked on top of a processing unit (e.g., CPU and/or GPU). In one or more implementations, stacking the memory stack on top of a processing unit can provide further connectivity and performance advantages relative to connections through silicon interposers.

FIG. 4 depicts a non-limiting example 400 of a printed circuit board architecture for a high bandwidth memory system. The illustrated example is an example architecture in which power management using temperature gradient information is implementable. Certainly, power management using temperature gradient information is implementable with a variety of other architectures, including with one or more of the components of the example architecture, without departing from the spirit or scope of the described techniques.

The illustrated example 400 includes a printed circuit board 402, which is depicted as a multi-layer printed circuit board in this case. In one example, the printed circuit board 402 is used to implement a graphics card. It should be appreciated that the printed circuit board 402 can be used to implement other computing systems without departing from the spirit or scope of the described techniques, such as a central processing unit (CPU), a graphics processing unit (GPU), a field programmable gate array (FPGA), an accelerated processing unit (APU), and a digital signal processor (DSP), to name just a few.

In the illustrated example 400, the layers of the printed circuit board 402 also include a package substrate 404, a silicon interposer 406, processor chip(s) 408, memory dies 410 (e.g., DRAM dies), and a controller die 412 (e.g., a high bandwidth memory (HBM) controller die). The illustrated example 400 also depicts a plurality of solder balls 414 between various layers. Here, the example 400 depicts the printed circuit board 402 as a first layer and the package substrate 404 as a second layer with a first plurality of solder balls 414 disposed between the printed circuit board 402 and the package substrate 404. In one or more implementations, this arrangement is formed by depositing the first plurality of the solder balls 414 between the printed circuit board 402 and the package substrate 404. Further, the example 400 depicts the silicon interposer 406 as a third layer, with a second plurality of the solder balls 414 deposited between the package substrate 404 and the silicon interposer 406. In this example 400, the processor chip(s) 408 and the controller die 412 are depicted on a fourth layer, such that a third plurality of the solder balls 414 are deposited between the silicon interposer 406 and the processor chip(s) 408 and a fourth plurality of the solder balls 414 are deposited between the silicon interposer 406 and the controller die 412. In this example, the memory dies 410 form an additional layer (e.g., a fifth layer) arranged “on top” of the controller die 412. The illustrated example 400 also depicts through silicon vias 416 in each die of the memory dies 410 and in the controller die 412, such as to connect these various components.

It is to be appreciated that systems for power management using temperature gradient information may be implemented using different architectures in one or more variations without departing from the spirit or scope of the described techniques. For example, any of the above-discussed components (e.g., the printed circuit board 402, the package substrate 404, the silicon interposer 406, the processor chip(s) 408, the memory dies 410 (e.g., DRAM dies), and the controller die 412 (e.g., a high bandwidth memory (HBM) controller die) may be arranged in different positions in a stack, side-by-side, or a combination thereof in accordance with the described techniques. Alternatively or in addition, those components may be configured differently than depicted, e.g., the memory dies 410 may include only a single die in one or more variations, the architecture may include one or more processor chips 408, and so forth. In at least one variation, one or more of the described components are not included in an architecture for implementing power management using temperature gradient information in accordance with the described techniques.

In this example 400, the processor chip(s) 408 is depicted including logic engine 418, a first controller 420, and a second controller 422. In variations, the processor chip(s) 408 includes more, different, or fewer components without departing from the spirit or scope of the described techniques. In one or more implementations, such as graphics card implementations, the logic engine 418 is configured as a three-dimensional (3D) engine. Alternatively or in addition, the logic engine 418 is configured to perform different logical operations, e.g., digital signal processing, machine learning-based operations, and so forth. In one or more implementations, the first controller 420 corresponds to a display controller. Alternatively or in addition, the first controller 420 is configured to control a different component, e.g., any input/output component. In one or more implementations, the second controller 422 is configured to control the memory, which in this example 400 includes the controller die 412 (e.g., a high bandwidth memory controller die) and the memory dies 410 (e.g., DRAM dies). Accordingly, one or more of the second controller 422 and/or the controller die 412 corresponds to the controller 108 in one or more implementations. Given this, in one or more implementations, the memory dies 410 correspond to the memory 110.

The illustrated example 400 also includes a plurality of data links 424. In one or more implementations, the data links 424 are configured as 1024 data links, are used in connection with a high bandwidth memory stack, and/or having a speed of 500 megahertz (MHz). In one or more variations, such data links are configured differently. Here, the data links 424 are depicted linking the memory (e.g., the controller die 412 and the memory dies 410) to the processor chip(s) 408, e.g., to an interface with the second controller 422. In accordance with the described techniques, data links 424 are useable to link various components of the system.

In one or more implementations, one or more of the solder balls 414 and/or various other components (not shown), such as one or more of the solder balls 414 disposed between the printed circuit board 402 and the package substrate 404, are operable to implement various functions of the system, such as to implement Peripheral Component Interconnect Express (PCIe), to provide electrical current, and to serve as computing-component (e.g., display) connectors, to name just a few.

It should be understood that many variations are possible based on the disclosure herein. Although features and elements are described above in particular combinations, each feature or element is usable alone without the other features and elements or in various combinations with or without other features and elements.

The various functional units illustrated in the figures and/or described herein (including, where appropriate, the memory 110, the controller 108, and the core 106) are implemented in any of a variety of different manners such as hardware circuitry, software or firmware executing on a programmable processor, or any combination of two or more of hardware, software, and firmware. The methods provided are implemented in any of a variety of devices, such as a general-purpose computer, a processor, or a processor core. Suitable processors include, by way of example, a general purpose processor, a special purpose processor, a conventional processor, a digital signal processor (DSP), a graphics processing unit (GPU), a parallel accelerated processor, a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

In one or more implementations, the methods and procedures provided herein are implemented in a computer program, software, or firmware incorporated in a non-transitory computer-readable storage medium for execution by a general-purpose computer or a processor. Examples of non-transitory computer-readable storage mediums include a read only memory (ROM), a random-access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A system comprising:
a processor;
a first thermal sensor positioned at a first portion of the processor;
a second thermal sensor positioned at a second portion of the processor; and
a system manager configured to:
obtain a first temperature measurement from the first thermal sensor and a second temperature measurement from the second thermal sensor;
predict a temperature of a hotspot on the processor based on the first temperature measurement and the second temperature measurement; and
adjust one or more settings of the processor based on the predicted temperature of the hotspot.

2. The system of claim 1, wherein the predicted temperature at the hotspot is higher than the first temperature measurement and the second temperature measurement.

3. The system of claim 1, wherein the hotspot is located at a different portion of the processor from where the first thermal sensor and the second thermal sensor are disposed.

4. The system of claim 1, wherein the system manager is configured to predict the temperature of the hotspot by:
determining a temperature delta between the first temperature measurement and the second temperature measurement;
determining a slope of the temperature delta; and
predicting the temperature of the hotspot based on the slope of the temperature delta.

5. The system of claim 1, wherein the first thermal sensor and the second thermal sensor are positioned at first and second portions of a core of the processor.

6. The system of claim 5, wherein the system manager is further configured to adjust the one or more settings of the core to keep temperature measurements from the first thermal sensor within a threshold of temperature measurements from the second thermal sensor.

7. The system of claim 1, wherein the first thermal sensor is positioned at a first core of the processor and the second thermal sensor is positioned at a second core of the processor.

8. The system of claim 7, wherein the system manager is further configured to adjust the one or more settings of at least one of the first core or the second core to keep temperature measurements from the first thermal sensor within a threshold of temperature measurements from the second thermal sensor.

9. The system of claim 1, wherein the system is a system-on-chip.

10. A method comprising:
obtaining temperature measurements of a component from two or more sensors of the component;
predicting a temperature of a hotspot of the component based on the temperature measurements obtained from the two or more sensors of the component; and
adjusting operation of the component based on the predicted temperature of the hotspot.

11. The method of claim 10, wherein the hotspot is located at a different portion of the component from where the two or more sensors are disposed.

12. The method of claim 10, wherein the predicted temperature of the hotspot is higher than the obtained temperature measurements.

13. The method of claim 10, wherein the component comprises a processor.

14. The method of claim 10, wherein the component comprises a memory.

15. The method of claim 10, wherein the predicting further comprises:
determining a temperature delta between the temperature measurements obtained from the two or more sensors of the component;
determining a slope of the temperature delta between the two or more sensors of the component; and
predicting the temperature of a hotspot of the component based on the slope of the temperature delta between the two or more sensors of the component.

16. The method of claim 10, wherein the adjusting keeps the temperature measurements from the two or more sensors within a threshold temperature difference.

17. A device comprising:
a stacked memory having a plurality of memory dies; and
a system manager configured to:
obtain temperature measurements from thermal sensors associated with different memory dies of the stacked memory;
predict a hotspot of the stacked memory based on a difference between the temperature measurements from the thermal sensors; and
adjust one or more settings of the stacked memory based on the predicted hotspot.

18. The device of claim 17, wherein prediction of the hotspot predicts a temperature of the hotspot and a location within the stacked memory of the hotspot.

19. The device of claim 18, wherein the predicted location of the hotspot corresponds to at least one memory die of the plurality of memory dies.

20. The device of claim 17, wherein the thermal sensors are disposed at least one of on the plurality of memory dies or between the plurality of memory dies.
